(19) United States
(12) Patent Application Publication
(10) Pub. No.: US 2002/0053107 A1
(43) Pub. Date: May 9, 2002

(54) Lift for bedfast patient requiring bedpan

(76) Inventor: James Lee Hale, Naples, FL (US)

Correspondence Address: James L. Hale, 5796 Woodmere Lake Circle, Naples, FL, 34112, US

(21) Appl. No.: 09/954,062

(22) Filed: Sep. 18, 2001

Related U.S. Application Data
(60) Provisional application No. 60/246,695, filed on Nov. 9, 2000.

(51) Int. Cl. A61G 7/10

(52) U.S. Cl. 5/81.1 R

(57) ABSTRACT

The invention consists of an inflatable toilet seat shaped tube that is vulcanized to a nylon (or similar material) partial bed sheet. The sheet has two ropes or cords on each side to attach to the bed frame to keep the tube centered on the bed. A hose connects the toilet seat tube to a compressed air reservoir. A valve on the reservoir allows compressed air to inflate the tube raising the patient about 4 or 5 inches (the height of a bed pan). The bed pan can then be placed under the patient through the open end of the tube. After the bed pan is removed, the compressed air valve can be actuated to deflate the tube to a flat configuration. This invention will greatly reduce the pain and suffering of patients. This mechanical process replaces a manual process thereby reducing back strain and fatigue for nurses and caregivers.

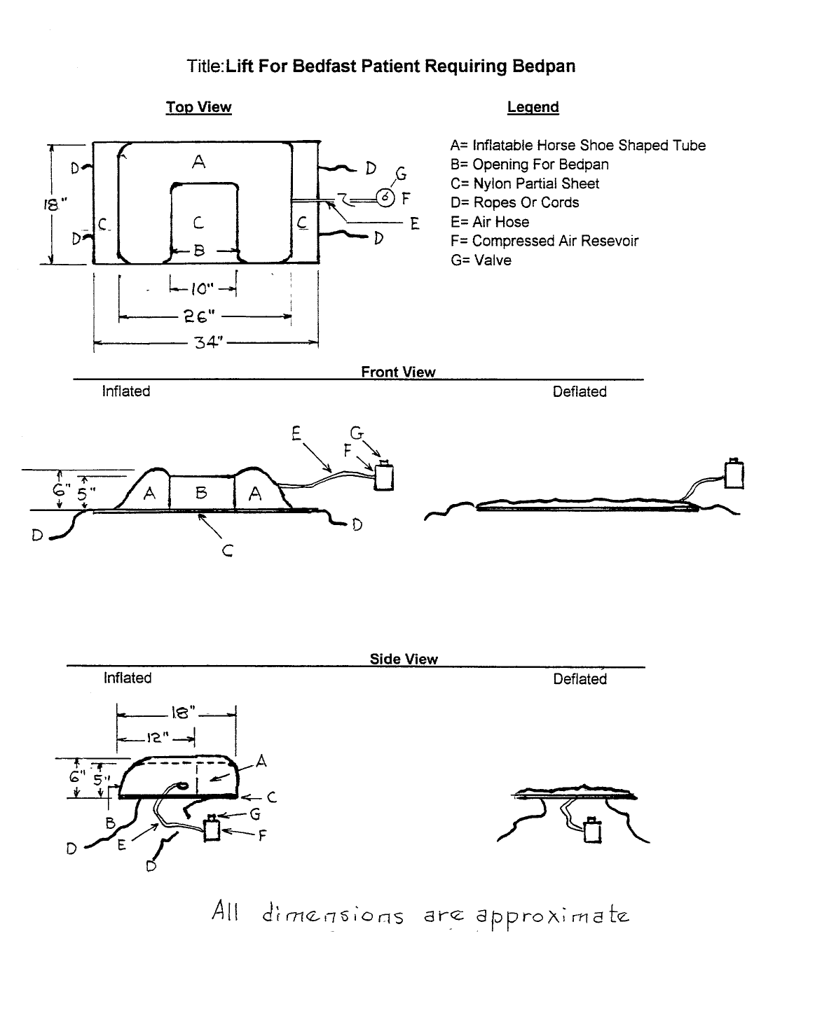

A provisional patent (application No. 60/246,695) with a filing date of Nov. 9, 2000 was granted for this invention.

The purpose of this invention is to facilitate raising and lowering a bedfast patient (either in a hospital, a care facility, or at home) that requires use of a bedpan. The invention will raise and lower a patient with much less discomfort for the patient than raising and lowering physically by individuals. The invention would also relieve a great deal of back strain on staff and individuals that provide this care.

The invention consists of an inflatable horse shoe shaped tube that is vulcanized to a nylon (or similar material) partial bed sheet. The sheet has two ropes or cords to tie to the bed frame to keep the tube centered on the bed. A hose approximately ¼″ (one-fourth inch) in diameter connects the horse shoe shaped tube to a compressed air reservoir. A valve on the reservoir allows compressed air to move through the hose into the horse shoe shaped tube thereby inflating the tube and raising the patient about 4 or 5 inches (the height of a bedpan). The bedpan can then be placed under the patient through the open end of the tube.

After the bedpan is removed, the compressed air valve can be actuated to “bleed off” the air in the tube thereby deflating the tube to a flat configuration until needed again.

I claim that this invention is my own idea and is based on observing a member of my family suffer through the need for physical lifting for bedpan use while confined to a bed. The invention may be used in a bed, wheel chair, or other adaptation.

The enclosed drawing (1) shows three views of the invention: Top view, front view, and side view.

I claim:

1. An inflatable lifting devise attached to a reclining or sitting structure comprising
a. a nylon, canvas or other suitable material partial sheet with attaching means to secure the location of the devise
b. a rubber, plastic or other suitable material inflatable tube attached to the above partial sheet
c. one or more ropes, cords or other suitable material attached at one end to the partial sheet and attached at the other end to the reclining or sitting structure
d. a hose assembly attached at one end to the inflatable tube and attached at the other end to a compressed air reservoir
e. a compressed air reservoir containing compressed air with a valve or valves allowing compressed air to enter the hose assembly and on into the tube thereby inflating said tube and a release valve or valves to deflate the tube
the devise is a means to raise and lower a person for the purpose of bedpan use and other lifting purposes thereby reducing pain and discomfort for the person requiring the use of the devise and reducing strain and injury to the caregiver operating the devise which replaces the need to physically lift a person.
